(19) United States
(12) Patent Application Publication
(10) Pub. No.: US 2006/0032204 A1
(43) Pub. Date: Feb. 16, 2006

(54) Actuating device for a pond care device for removing filamentous algae and weeds

(76) Inventor: Albert Feinaugle, Wildberg (DE)

Correspondence Address: Bell, Boyd & Lloyd LLC, P.O. Box 1135, Chicago, IL, 60690-1135, US

(21) Appl. No.: 11/178,939

(22) Filed: Jul. 11, 2005

(30) Foreign Application Priority Data
Jul. 12, 2004 (CN) 200410069029.1

(51) Int. Cl. A01D 44/00

(52) U.S. Cl. 56/8

(57) ABSTRACT

Actuating device for a pond care device for removing filamentous algae. Due to the specific design of the operating device, it is ensured that the operating forces for the grip are the same for all devices, incorrect operation due to incorrect interpretation of the functioning of the device is constructively excluded, and a difficult rethreading due to drawing the grip out too far is also no longer required. Especially for larger ponds, work is made easier by the motor-driven rotational movement of the brush, which can be achieved either through a motor packet integrated into the tube or through an externally attached commercially available screwdriver.

### BACKGROUND OF THE INVENTION

In garden ponds, aquariums, and areas in which aquatic plants are found, the problem of undesirable water quality often arises. This can be caused by excess nutrients in the water that result in the growth of algae. Algae growing in long filaments (approximately 10 cm long; diameter comparable to that of a human hair) are particularly undesirable. These algae form spongy areas that are aesthetically very unattractive. Fighting them with chemicals is generally undesirable, due to the known disadvantages. The only solution generally adopted is to fight them mechanically by collecting and removing the algae filaments.

A device (“A weed collecting device,” GB 2 328 899) is known that consists of a winding element that is made of a conically tapered toothed rod and is fastened to the end of an extension rod or tube. Filamentous algae are wound onto the winding element and are removed from the water, and can be stripped off using a manually movable stripping tube that is pushed over the extension rod.

DE10152225 and EP1305996A1 describe a manually operated device for collecting and removing filamentous algae and weeds from ponds, having an integrated stripping device. Here, a standard commercially available rotating brush is used as a winding element for the filamentous algae or weeds. After being wound on, the filamentous algae can be stripped off by moving a grip (“back and forward again”), because in this motion the brush with the wound-on algae is drawn through a comb-type stripper and the algae are stripped away and fall off. When the grip is pushed back into its initial position, the cleaned brush appears again (FIG. 1, Prior Art).

In all the described devices, a linear manual shifting motion of a grip is necessary in order to strip off the wound-on filamentous algae.

Products are commercially available that have a stripping device that has been patented under DE10152225 and EP1305996 A1 (see instruction manual, “Algenhexe” [“Algae Wizard”], made by the company MAW Teichtechnik), and FIG. 1, Prior Art. The commercial manufacturability and user-friendliness of these devices currently still leave something to be desired. In devices according to DE10152225 and EP1305996 A1, a rotation of the grip against the aluminum tube is undesirable, because this rotary motion is transmitted to the brush, and thus damages the portion of the bristles that are in the comb-type stripper. Moreover, the mere fact that it is possible to rotate the grip itself often leads to a mistaken interpretation of the functioning of the device. Many users try to wind the filamentous algae onto the device by rotating the grip. However, the rotary motion for the winding of the filamentous algae is supposed to be executed by rotating the entire device about its longitudinal axis, which is considerably faster and easier. The grip is intended solely for the stripping process, which is supposed to be carried out by a linear shifting motion. Another disadvantage of the existing devices is the lack of a mechanical stop that limits the shifting motion. Thus, the grip can be drawn too far, and must then be laboriously threaded back into the main tube of the device. An alternative to a mechanical stop is a grip that can be drawn well beyond the required actuation distance, without then having to be rethreaded into the device.

In practice, certain tolerances always have to be accepted in the manufacture of the parts of a device. In the existing design, these tolerances can disadvantageously have the result that the grip either moves too easily and unintentionally falls off due to its own weight, or else, at the other extreme, sticks. The required tolerances can be achieved in the existing designs only through expensive, laborious measures.

### SUMMARY OF THE INVENTION

The present invention relates to an actuating device for pond care devices that removes all the cited disadvantages and simultaneously permits economical mass production. The fundamental innovation is in the manner of operation of the grip mechanics.

Additional features and advantages of the present invention are described in, and will be apparent from, the following Detailed Description of the Invention and the figures.

### BRIEF DESCRIPTION OF THE FIGURES

FIG. 1 illustrates a prior art device.

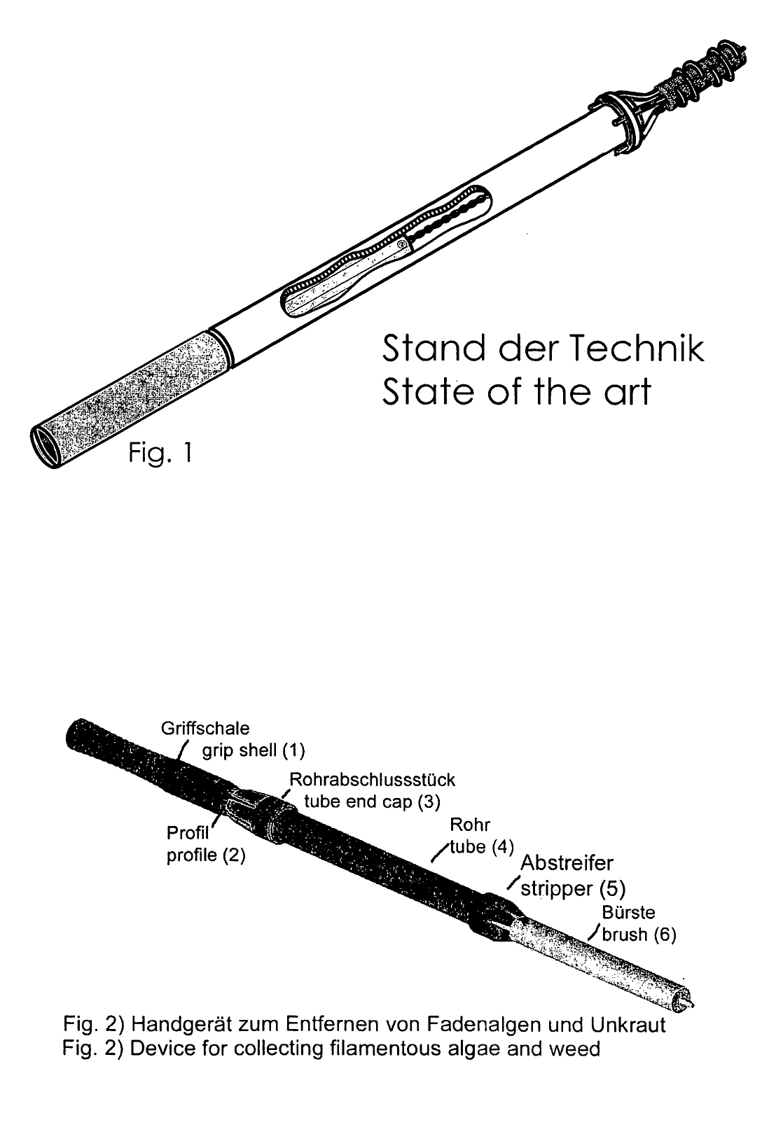

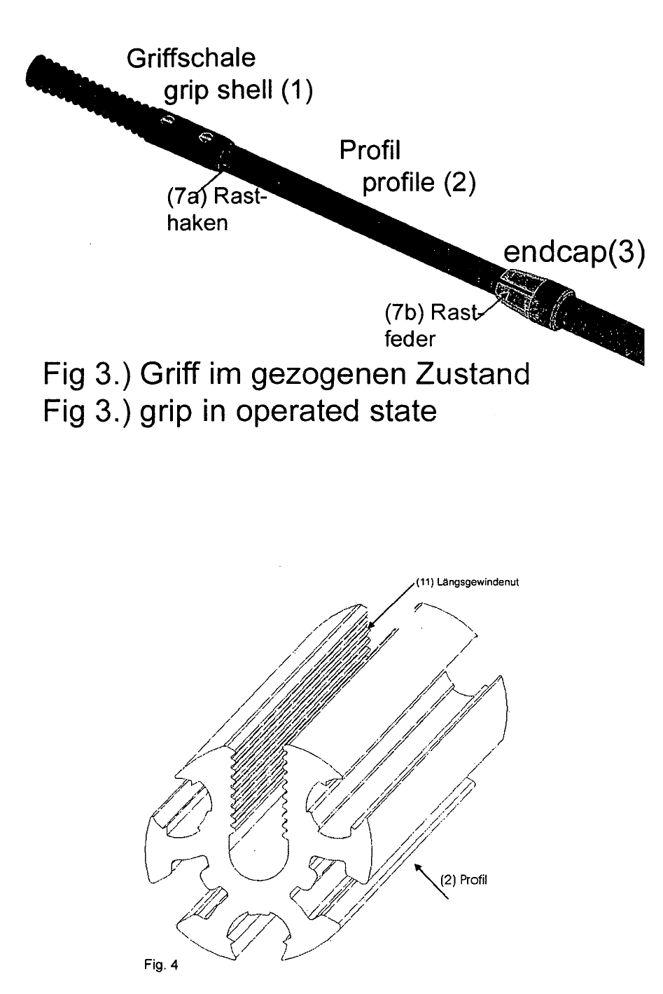

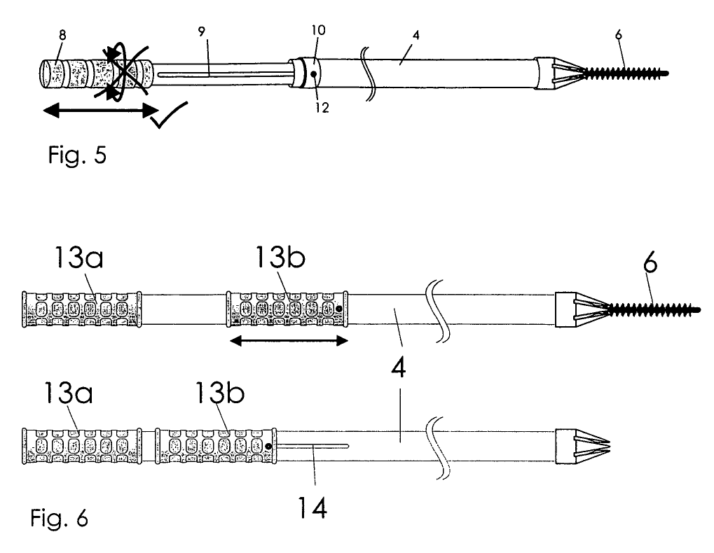

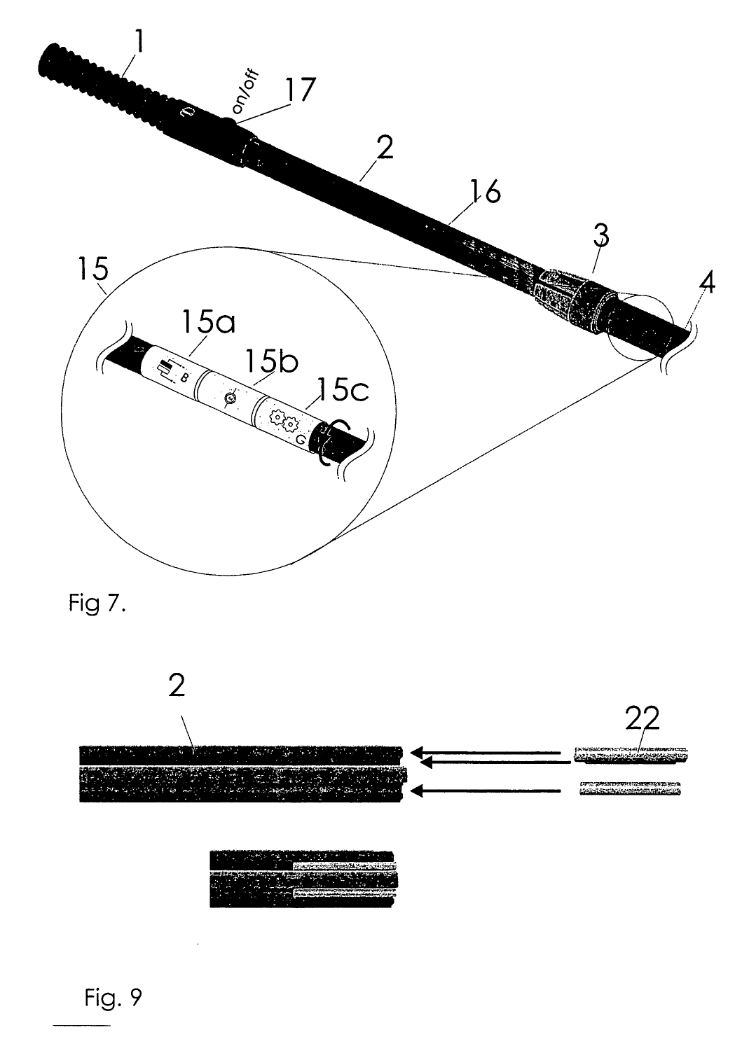

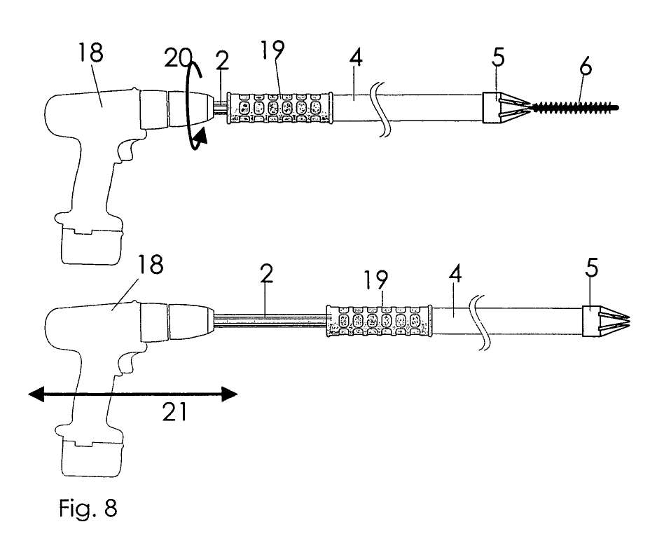

Several exemplary embodiments are described in detail (FIG. 2—FIG. 9).

### DETAILED DESCRIPTION OF THE INVENTION

An embodiment having a two-part grip is indicated in FIG. 2. A profile (2) runs in the main tube (4) of the device. A grip shell (1) can be fastened to one end of the profile by screws. At the other end of the profile (2), screws can be used to fasten the brush in the same longitudinal threading groove (11) with one or more screws. At the end of the main tube (4) remote from the stripper (5), there is situated a tube end cap (3). The shape of the profile (2) and of the tube end cap (3) are chosen such that a linear movement of the profile and thus of the grip is possible, but a rotation of the grip is prevented by a positive connection. Moreover, the tube end cap (3) is resilient (7b) and thus compensates manufacturing tolerances in the outer diameter of the profile (2) and in the inner diameter of the main tube (4). It thus contributes to a reduction of costs by allowing greater manufacturing tolerances. The tube end cap (3) is also responsible for the determination of the desired operating forces of the grip. In the closed state of the device (grip completely pushed in), a holding force is desirable in order to prevent the grip from falling out in every position of the device. During operation, however, the forces should be as low as possible in order to prevent user fatigue. For this reason, parts of the grip shell (1) (locking hooks (7a)) and of the tube end cap (3) (locking springs (7b)) lock resiliently with one another when the grip is pushed in. The desired grip actuation forces result from the constructively determined rigidity of these parts. Due to the profile (2) that extends continuously up to the brush (6), it is possible to draw out the grip arbitrarily far without disadvantages; it is not necessary to repeatedly rethread the grip into the main tube (4), as is the case in the existing design. The tube end cap (3) and the stripper (5) are fastened in an identical manner to the main tube (4), namely through a reshaping of the tube (4) by a forming die. The reshaping takes place in the area of the slits of the stripper or tube end cap. Here, after the stripper or tube end cap has been put into place, the tube is reshaped outward in the area of these slits (flanging), thereafter preventing the parts on the tube from being pulled off or rotated.

An embodiment with a one-part grip (8) without the use of a profile is shown in FIG. 5. The rod-shaped part of the grip (8) runs in the main tube (4). For reasons of weight and costs, this rod-shaped part is however not led through the entire tube (4) up to the brush (6), but rather is connected to a suitable extension that covers the distance up to the brush. Here as well, a tube end cap (10) is used. The shape of the grip (8) and of the tube end cap (10) are selected such that a linear shifting of the grip is possible, but a rotating of the grip is not possible. In the simplest case, this is accomplished by a longitudinal groove (9) in the rod-shaped part of the grip. A web of the tube end cap or a screw (12) or pin engages in this groove. The tube end cap can either be seated on the end of the tube or, as shown in FIG. 5, can be displaced somewhat towards the direction of the center of the tube. However, an advantage of a seating at the end of the tube is that it can have a resilient construction, so that manufacturing tolerances between the outer diameter of the grip and the inner diameter of the main tube can be compensated, and the desired resilient locking between the grip and the tube end cap when the grip is completely pushed in can be achieved by a corresponding shaping of the grip (8) and the tube end cap (10) (analogous to FIG. 2 and FIG. 3).

Another alternative is shown in FIG. 6. Here, the main tube (4) has an oblong opening (14). A snugly seated grip shell (13a) and a grip shell (13b) that can be shifted longitudinally are attached to the main tube. Through the oblong opening, the grip shell (13b) is connected to interior parts that transmit the linear shifting motion during stripping up to the brush (6). The maximum linear shifting path can be defined by the shape of the opening (14); an undesirable rotation is simultaneously prevented.

For larger ponds and longer work operations using the cited devices, the desire often arises of executing at least the rotational motion using a motor, because this motion is the one that most quickly becomes tiring. In the devices having motor-driven rotational movement of the brush, the principle is abandoned of rotating the entire device in order to wind the algae onto the device. Rather, a motor-driven rotation of the brush takes place inside the device. The brush (6) is modified in such a way that the bristles do not begin until outside the stripper (5), so that the bristles cannot be sheared off by the rotation.

FIG. 7 shows an embodiment having a packet (15), integrated into the tube (4) of the device, made up of an energy source (15a), a motor (11b), and, optionally, a transmission (15c). The switching of the motor on and off can take place via a switch (17) on the grip, connected to the packet (15) by a cable (16), or by a switch that is operated magnetically in contactless fashion after the grip is pushed in completely.

FIG. 8 shows an embodiment having a motor-driven rotational motion (20) using a standard commercially available drill (18) or motorized screwdriver (18). The tube end cap (19), which prevents a rotation of the grip in the manual device and in devices according to FIG. 7, is in this embodiment a plain bearing or ball bearing for the profile (2) that permits both a rotational motion (20) and also a linear shifting motion (21) of the profile (2) in the main tube (4). In the exemplary embodiment according to FIG. 8, the tube end cap (19) is simultaneously realized as a grip shell. The winding of the filamentous algae takes place through the rotational movement (20) of the screwdriver, which is transmitted to the brush (6) via the profile (2). After the cessation of the rotational motion, the wound-on algae can be stripped off by the linear shifting motion (21), which is likewise transmitted to the brush (6) via the profile (2), because the brush (6) is drawn through the comb-type stripper (5).

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. Actuating device for a pond care device for removing filamentous algae, comprising a grip having at least one-part, the grip extends at least partly into a tube of the device, a tube end cap connected to the tube for positively engaging the grip in order to enable a desired rotational securing of the grip in relation to the device, and a desired linear mobility of the grip simultaneously being enabled.

2. Actuating device for a pond care device according to claim 1, wherein a one-part grip is used, the grip part that extends into the tube of the device has at least one longitudinal groove, having arbitrary shapes, that enable the positive engagement of the tube end cap so that a rotational securing of the grip is achieved.

3. Actuating device for a pond care device according to claim 1, wherein a multipart grip is used, the part of the grip that extends into the tube of the device has an arbitrary profile bearing at its end a grip shell so as to complete the grip, and whose shape is adapted to the tube end cap so as to allow the desired rotational securing results, and having length such that there is no risk of its becoming unthreaded from the tube even when a maximum operating stroke is significantly exceeded.

4. Actuating device for a pond care device for removing filamentous algae, comprising an at least one-part grip that extends partly in a tube of the device, a tube end cap, connected to the tube, that engages resiliently in the grip when the grip is closed, providing a minimum holding force required to prevent an automatic falling out of the grip in any position, and providing an operating force that is as low as possible for the linear shifting motion of the grip.

5. Actuating device for a pond care device according to claim 1, wherein the shape of the profile is selected such that the profile has a longitudinal threading groove, in which both the grip shell can be fastened at the one end of the profile and also the brush can be fastened at the other end of the profile, using screws.

6. Actuating device for a pond care device according to claim 1, wherein the shape of the interior profile is selected such that at the end of the profile spacing pieces having an arbitrary suitable shape and made of a suitable material can be fastened preventing a direct contact between the profile running in the tube and the tube itself, thus preventing an undesirable rattling of the device during motion, and improving the sliding properties between the tube and the profile.

7. Actuating device for a pond care device according to claim 1, wherein the shape of the tube end cap is selected such that it can be fastened to the other end of the tube in the same manner as a stripper.

8. Actuating device for a pond care device according to claim 1, wherein the tube end cap is attached so as to be displaced somewhat in the direction towards a center of the tube, the positive connection with the grip taking place via a screw or pin through an opening in the wall of the tube.

9. Actuating device for a pond care device comprising a tube having an oblong opening which, through its shape, effects a rotational securing and simultaneously a limitation of the linear shifting motion, and through which an externally situated grip shell that can be moved longitudinally can be connected to interior parts, which provides transmission of the shifting motion to a brush.

10. Actuating device for a pond care device according to claim 1, comprising a packet made up of an energy source, and a motor integrated into the tube of the device to provide a motor-driven rotation of a brush.

11. Actuating device for a pond care device for removing filamentous algae, comprising a drill or screwdriver and a connecting part situated in the tube of the device, the bearing of the connecting part in the tube being such that, the motor-driven rotational motion about a longitudinal axis is enabled, and a manual linear shifting along the longitudinal axis is enabled.

12. Actuating device for a pond care device according to claim 1, wherein the one or more longitudinal grooves having arbitrary shapes that enable a mechanical stop for the pulling out of the grip when the maximum operating stroke has been achieved.

13. Actuating device for a pond care device according to claim 4, wherein a one-part grip is used, the grip part that extends into the tube of the device has at least one longitudinal groove, having arbitrary shapes, that enable the positive engagement of the tube end cap so that a rotational securing of the grip is achieved.

14. Actuating device for a pond care device according to claim 4, wherein a multipart grip is used, the part of the grip that extends into the tube of the device has an arbitrary profile bearing at its end a grip shell so as to complete the grip, and whose shape is adapted to the tube end cap so as to allow the desired rotational securing results, and having length such that there is no risk of its becoming unthreaded from the tube even when a maximum operating stroke is significantly exceeded.

15. Actuating device for a pond care device according to claim 4, wherein the shape of the profile is selected such that the profile has a longitudinal threading groove, in which both the grip shell can be fastened at the one end of the profile and also the brush can be fastened at the other end of the profile, using screws.

16. Actuating device for a pond care device according to claim 5, wherein the shape of the interior profile is selected such that at the end of the profile spacing pieces having an arbitrary suitable shape and made of a suitable material can be fastened in some suitable manner preventing a direct contact between the profile running in the tube and the tube itself, thus preventing an undesirable rattling of the device during motion, and improving the sliding properties between the tube and the profile.

17. Actuating device for a pond care device according to claim 3, wherein the shape of the tube end cap is selected such that it can be fastened to the other end of the tube in the same manner as a stripper.

18. Actuating device for a pond care device according to claim 4, wherein the shape of the tube end cap is selected such that it can be fastened to the other end of the tube in the same manner as a stripper.

19. Actuating device for a pond care device according to claim 3, wherein the tube end cap is attached so as to be displaced somewhat in the direction towards a center of the tube, the positive connection with the grip taking place via a screw or pin through an opening in the wall of the tube.

20. Actuating device for a pond care device according to claim 4, wherein the tube end cap is attached so as to be displaced somewhat in the direction towards a center of the tube, the positive connection with the grip taking place via a screw or pin through an opening in the wall of the tube.

21. Actuating device for a pond care device according to claim 3, comprising a packet made up of an energy source, and a motor integrated into the tube of the device to provide a motor-driven rotation of a brush.

22. Actuating device for a pond care device according to claim 4, comprising a packet made up of an energy source, and a motor integrated into the tube of the device to provide a motor-driven rotation of a brush.

23. Actuating device for a pond care device according to claim 9, comprising a packet made up of an energy source, and a motor integrated into the tube of the device to provide a motor-driven rotation of a brush.

24. Actuating device for a pond care device according to claim 11, wherein a one-part grip is used, the part of the grip that extends into the tube of the device has at least one longitudinal groove, having arbitrary shapes, that enable the positive engagement of the tube end cap so that a rotational securing of the grip is achieved.

25. Actuating device for a pond care device according to claim 11, wherein a multipart grip is used, the part of the grip that extends into the tube of the device has an arbitrary profile bearing at its end a grip shell so as to complete the grip, and whose shape is adapted to the tube end cap so as to allow the desired rotational securing results, and having length such that there is no risk of its becoming unthreaded from the tube even when a maximum operating stroke is significantly exceeded.

26. Actuating device for a pond care device according to claim 11, wherein the shape of the profile is selected such that the profile has a longitudinal threading groove, in which both the grip shell can be fastened at the one end of the profile and also the brush can be fastened at the other end of the profile, using screws.

27. Actuating device for a pond care device according to claim 11, wherein the shape of the interior profile is selected such that at the end of the profile spacing pieces having an arbitrary suitable shape and made of a suitable material can be fastened in some suitable manner preventing a direct contact between the profile running in the tube and the tube itself, thus preventing an undesirable rattling of the device during motion, and improving the sliding properties between the tube and the profile.

28. Actuating device for a pond care device according to claim 11, wherein the shape of the tube end cap is selected such that it can be fastened to the other end of the tube in the same manner as a stripper.
